(19) United States
(12) Patent Application Publication
(10) Pub. No.: US 2012/0031242 A1
(43) Pub. Date: Feb. 9, 2012

(54) Anti-Rolling Socket

(76) Inventors: Yi-Min Li, Dali City (TW); Andreas Dierolf, Untermunkheim (DE)

(21) Appl. No.: 12/850,169

(22) Filed: Aug. 4, 2010

(51) Int. Cl. B25B 13/06; B25B 23/00

(52) U.S. Cl. 81/121.1; 81/184

(57) ABSTRACT

An anti-rolling socket includes ribs extending thereon in parallel to an axis thereof. Two adjacent ones of the ribs are in contact with a planar face when the anti-rolling socket is laid on the planar face. In an aspect, the ribs are merged with the anti-rolling socket. In another aspect, the ribs are formed on a ring located on the anti-rolling socket.

### BACKGROUND OF INVENTION

1. Field of Invention

The present invention relates to a socket and, more particularly, to an anti-rolling socket.

2. Related Prior Art

A conventional socket includes a smooth circular periphery. When the conventional socket is located on a planar face of a table or a bench for example, the conventional socket often rolls on the planar face and, in the worst scenario, falls onto the ground or a floor from the table or the bench. A user has to pay attention to the conventional socket and gets distracted from what he or she is doing.

To avoid rolling, some sockets include polygonal peripheries. To make such a socket, a piece of metal is made into a socket with a circular periphery by casting. The circular periphery is cut into a polygonal periphery. Then, the socket is subjected to thermal treatment and electroplating. The portion of the metal that is cut from the socket is however a waste since materials are quite expensive. The thermal treatment and the electroplating further increase the cost of the socket.

As disclosed in Taiwanese Patent No. M374393, a socket 20 includes a circular periphery 26. A plastic ring 30 is located in an annular groove 28 defined in the circular periphery 26. The plastic ring 30 includes facets 32. One of the facets 32 is supposed to contact a planar face and prevent the socket 20 from rolling on the planar face. However, the socket 20 often rolls on the planar face for reasons. At first, the plastic ring 30 sticks out from the periphery 26. Secondly, the ring 30 is narrow so that an end of the socket 20 is in contact with the planar face when the socket 20 is laid on the planar face. Thirdly, the length of each of the facets 32 is inadequate. Thus, even formed with the facets 32, the ring 30 acts like a wheel to facilitate the rolling of the socket 20, with the end of the socket 20 in contact with the planar face.

The present invention is therefore intended to obviate or at least alleviate the problems encountered in prior art.

### SUMMARY OF INVENTION

It is the primary objective of the present invention to provide an anti-rolling socket.

To achieve the foregoing objective, the anti-rolling socket includes ribs extending thereon in parallel to an axis thereof. Two adjacent ones of the ribs are in contact with a planar face when the anti-rolling socket is laid on the planar face.

In an aspect, the ribs are merged with the anti-rolling socket.

In another aspect, the ribs are formed on a ring located on the anti-rolling socket.

Other objectives, advantages and features of the present invention will be apparent from the following description referring to the attached drawings.

### BRIEF DESCRIPTION OF DRAWINGS

The present invention will be described via detailed illustration of five embodiments referring to the drawings wherein:

FIG. 1 is a perspective view of an anti-rolling socket according to the first embodiment of the present invention;

FIG. 2 is a cross-sectional view of the anti-rolling shown in FIG. 1;

FIG. 3 is another cross-sectional view of the anti-rolling shown in FIG. 1;

FIG. 4 is a perspective view of an anti-rolling socket according to the second embodiment of the present invention;

FIG. 5 is a perspective view of an anti-rolling socket according to the third embodiment of the present invention;

FIG. 6 is a cross-sectional view of an anti-rolling socket according to the fourth embodiment of the present invention; and

FIG. 7 is a cross-sectional view of an anti-rolling socket according to the fifth embodiment of the present invention.

### DETAILED DESCRIPTION OF EMBODIMENTS

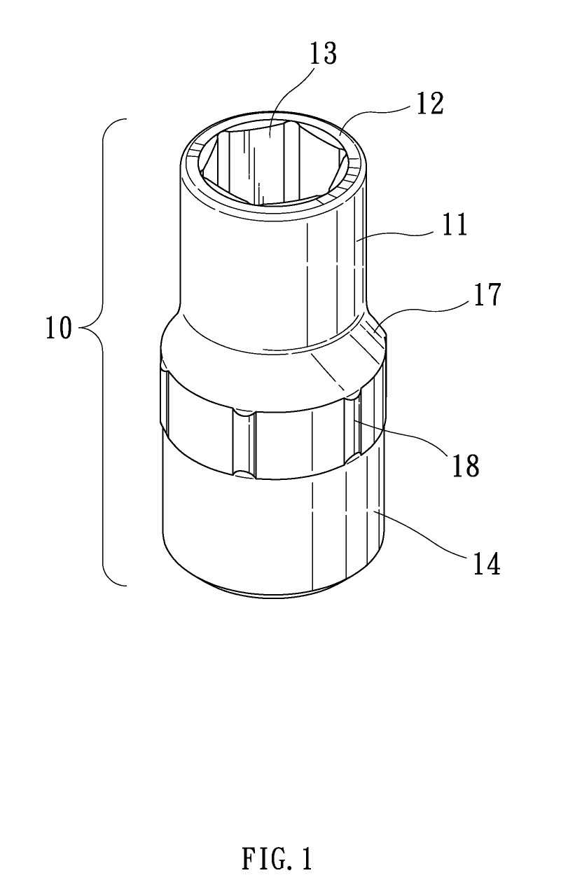

Referring to FIGS. 1 through 3, there is shown an anti-rolling socket 10 according to a first embodiment of the present invention. The anti-rolling socket 10 includes a small section 11, a large section 14 and a waist 17 formed between the small section 11 and the large section 14. The diameter of the small section 11 is smaller than that of the large section 14. The waist 17 is tapered toward the small section 11 from the large section 14. The anti-rolling socket 10 includes a hexagonal cavity 13 defined in an end face 12 of the small section 11 and a square cavity 16 defined in an end face 15 of the large section 14. The hexagonal cavity 13 is in communication with the square cavity 16. The anti-rolling socket 10 includes ribs 18 longitudinally extending on the periphery of the large section 14.

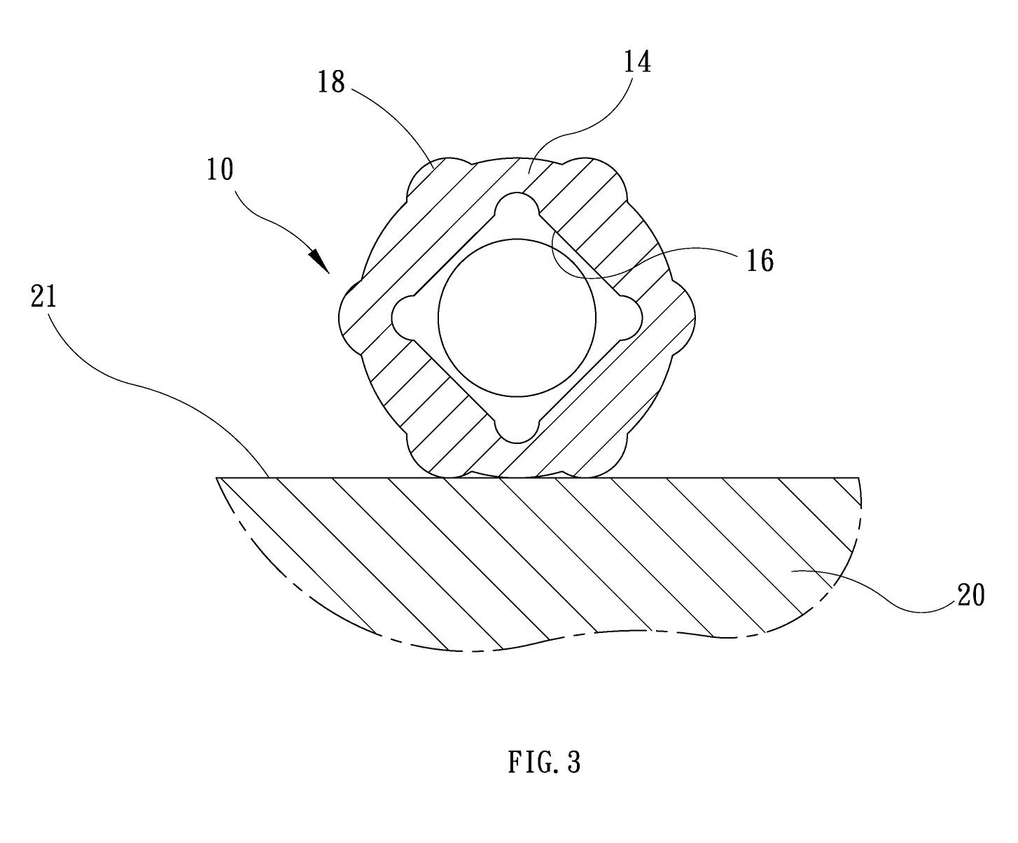

Referring to FIG. 3, the height of each of the ribs 18, which is measured from the periphery of the large section 14 to the peak of the rib 18 along a radius of the anti-rolling socket 10, is adequate. Thus, two of the ribs 18 and a portion of the periphery of the large section 14 contact a planar face 21 of a table 20 when the anti-rolling socket 10 is laid on the planar face 21.

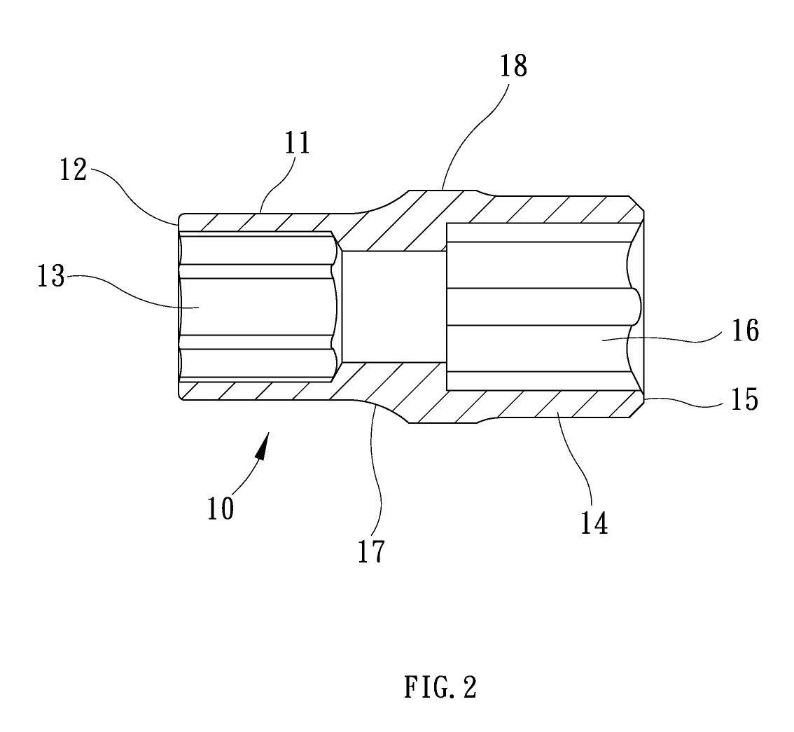

Referring to FIG. 2, the length of each of the ribs 18, which is measured from an end to an opposite end along the axis of the anti-rolling socket 10, is adequate. Thus, the axis of the anti-rolling socket 10 is always in parallel to the planar face 21 when the anti-rolling socket 10 is laid on the planar face 21. Hence, the anti-rolling socket 10 does not roll on the planar face 21, and none of the ends of the anti-rolling socket 10 is in contact with the planar face 21.

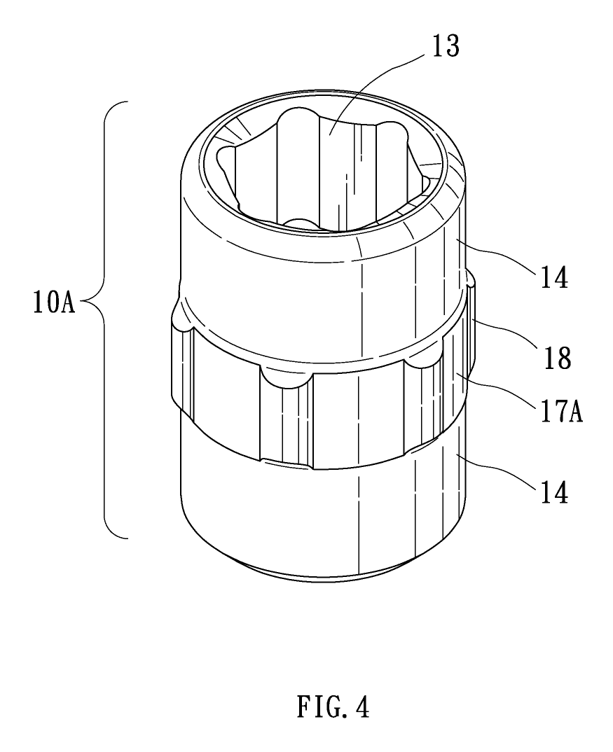

Referring to FIG. 4, there is shown an anti-rolling socket 10A according to a second embodiment of the present invention. The anti-rolling socket 10A is like the anti-rolling socket 10 except two things. At first, another section 14 is used instead of the small section 11. The hexagonal cavity 13 is defined in one of the sections 14. Secondly, a waist 17A is used instead of the waist 17. The diameter of the waist 17A remains the same along the axis of the anti-rolling socket 10A. The ribs 18 are formed on the waist 17A.

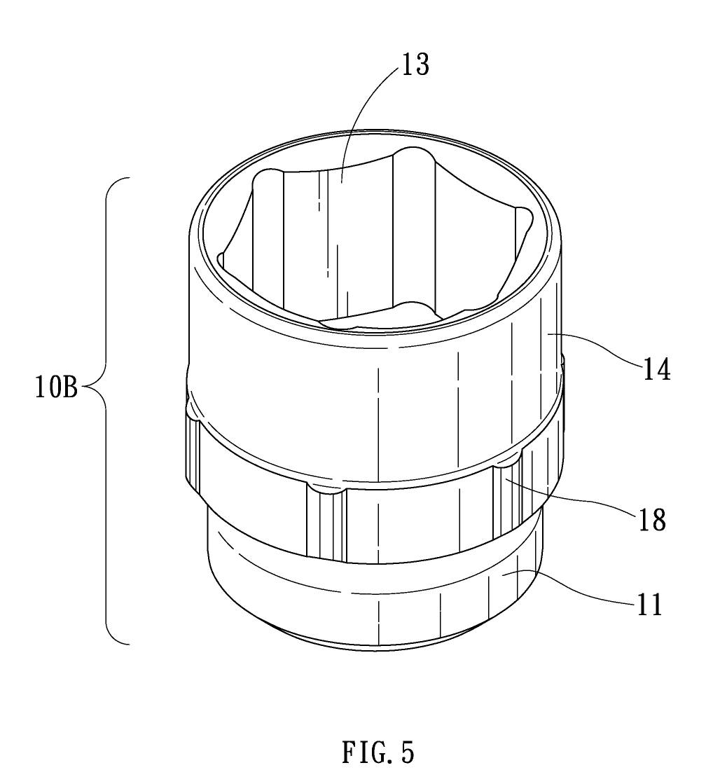

Referring to FIG. 5, there is shown an anti-rolling socket 10B according to a third embodiment of the present invention. The anti-rolling socket 10B is identical to the anti-rolling socket 10 except that the hexagonal cavity 13 is defined in the large section 14 while the square cavity 16 is defined in the small section 11.

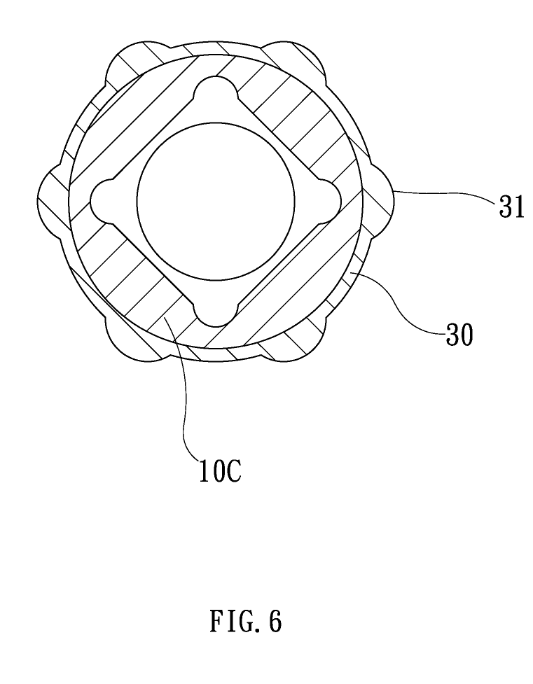

Referring to FIG. 6, there is shown an anti-rolling socket 10C according to a fourth embodiment of the present invention. The anti-rolling socket 10C is like the anti-rolling socket 10A except including ribs 31 formed on a ring 30 located thereon instead of the ribs 18 formed on the waist 17A. The ring 30 is preferably made of plastics so that it is elastic and tightly wraps the anti-rolling socket 10C. An adhesive material can be used to ensure the attachment of the ring 30 to the anti-rolling socket 10C.

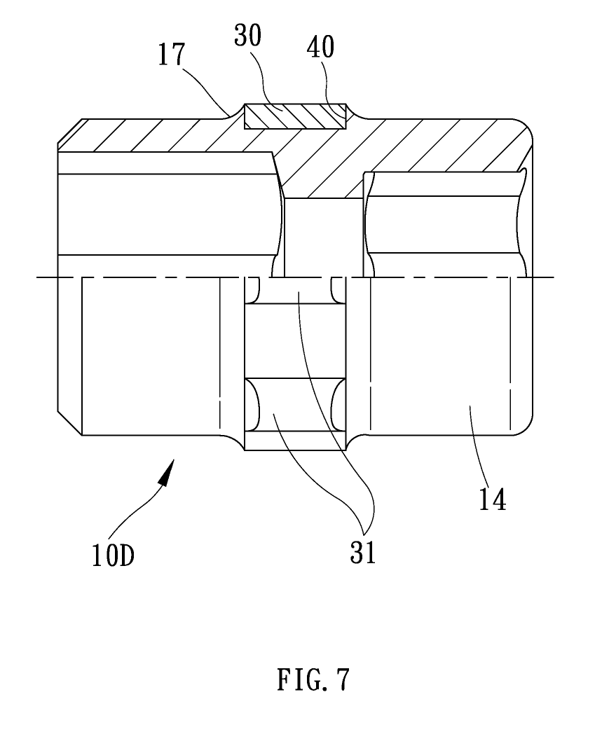

Referring to FIG. 7, there is shown an anti-rolling socket 10D according to a fifth embodiment of the present invention. The anti-rolling socket 10D is identical to the anti-rolling socket 10C except that the ring 30 is located in a groove 40 defined therein.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An anti-rolling socket including ribs extending thereon in parallel to an axis thereof, wherein two adjacent ones of the ribs are in contact with a planar face when the anti-rolling socket is laid on the planar face.

2. The anti-rolling socket according to claim 1, wherein each of the ribs is made with a height, which is measured along a radius of the anti-rolling socket so that two of the ribs and another portion of the anti-rolling socket are in contact with the planar face when the anti-rolling socket is laid on the planar face.

3. The anti-rolling socket according to claim 1, wherein each of the ribs is made with a length, which is measured along the axis of the anti-rolling socket so that the axis of the anti-rolling socket is always in parallel to the planar face when the anti-rolling socket is laid on the planar face.

4. An anti-rolling socket set including:
a socket; and
a ring including ribs extending thereon in parallel to an axis thereof,
wherein the ring is located on the socket, wherein two adjacent ones of the ribs are in contact with a planar face when the anti-rolling socket is laid on the planar face.

5. The anti-rolling socket set according to claim 4, wherein the socket includes a groove for receiving the ring.

6. The anti-rolling socket set according to claim 4, wherein each of the ribs is made with a height, which is measured along a radius of the ring, so that two of the ribs and another portion of the ring are in contact with the planar face when the anti-rolling socket set is laid on the planar face.

7. The anti-rolling socket set according to claim 4, wherein each of the ribs is made with a length, which is measured along the axis of the ring, so that the axis of the anti-rolling socket is always in parallel to the planar face when the anti-rolling socket is laid on the planar face.
